(19) United States
(12) Patent Application Publication
(10) Pub. No.: US 2024/0233015 A1
(43) Pub. Date: Jul. 11, 2024

(54) SYSTEM AND METHOD FOR ENERGY-BACKED INVESTMENTS

(71) Applicant: Wertheimer Ventures, LLC, Brookline, MA (US)

(72) Inventor: Jeremy WERTHEIMER, Brookline, MA (US)

(73) Assignee: Wertheimer Ventures, LLC, Brookline, MA (US)

(21) Appl. No.: 18/410,651

(22) Filed: Jan. 11, 2024

Related U.S. Application Data
(60) Provisional application No. 63/479,480, filed on Jan. 11, 2023.

(51) Int. Cl. G06Q 40/04

(52) U.S. Cl. CPC G06Q 40/04

(57) ABSTRACT

A computer-implemented method is provided for trading financial contracts related to a produced-energy product. The method comprises the steps of determining a unit price for each of the financial contracts, where the unit price being based at least on a market price for a contract-defined quantity of the produced-energy product in a predetermined market; establishing, on a computer system, a plurality of the financial contracts; and receiving, on the computer system, an order to purchase one or more of the financial contracts; and performing, by the computer system, one or more market-linked activities associated with the contract-defined quantity of the produced-energy product when one of the financial contracts is purchased.

### CROSS REFERENCE TO RELATED APPLICATIONS

This application claims the benefit of U.S. Provisional Patent Application Ser. No. 63/479,480, filed on Jan. 11, 2023, which is incorporated in their entirety herein by reference.

### TECHNOLOGICAL FIELD

The presently disclosed subject matter relates to financial markets, and in particular to systems configured to facilitate activities external to and linked to such financial markets.

### SUMMARY OF EMBODIMENTS

According to an aspect of the presently disclosed subject matter, there is provided a computer-implemented method for trading financial contracts related to a produced-energy product, the method comprising:
determining a unit price for each of the financial contracts, the unit price being based at least on a market price for a contract-defined quantity of the produced-energy product in a predetermined market;
establishing, on a computer system, a plurality of the financial contracts;
receiving, on the computer system, an order to purchase one or more of the financial contracts; and
performing, by the computer system, one or more market-linked activities associated with the contract-defined quantity of the produced-energy product when one of the financial contracts is purchased.

The market-linked activity may comprise establishing a right for the holder of one of the financial contracts to purchase the contract-defined quantity of the produced-energy product at a predefined future date at a defined price.

The market-linked activity may comprise designating a stored contract-defined quantity of the produced-energy product as being exclusively associated with the financial contract.

The market-linked activity may further comprise acquiring the designated contract-defined quantity.

The market-linked activity may further comprise producing the designated contract-defined quantity.

The contract-defined quantity may be acquired and stored no later than when the financial contract is established.

The produced-energy product may be stored in a system configured to facilitate providing energy to an economic agent and/or a distribution network of the predetermined market.

Storage of the produced-energy product may comprise converting at least a portion of it to chemical energy.

Storage of the produced-energy product comprises converting at least a portion of it to mechanical potential energy.

The mechanical potential energy may comprise gravitational energy.

The mechanical potential energy may be stored in a compressed fluid.

Storage of the produced-energy product may comprise converting at least a portion of it to thermal energy.

The produced-energy product may be electricity.

According to another aspect of the presently disclosed subject matter, there is provided a computer system for facilitating trade of financial contracts related to a produced-energy product, the system comprising:
a pricing module configured to determine a unit price for each of the financial contracts, the unit price being based at least on a market price for a contract-defined quantity of the produced-energy product in a predetermined market;
a trading module configured to establish a plurality of the financial contracts and to receive orders to purchase one or more of the financial contracts; and
a procurement module configured to perform one or more market-linked activities associated with the contract-defined quantity of the produced-energy product when one of the financial contracts is purchased.

The procurement module may be configured to establish a right for the holder of one of the financial contracts to purchase the contract-defined quantity of the produced-energy product at a predefined future date at a defined price.

The procurement module may be configured to designate a stored contract-defined quantity of the produced-energy product as being exclusively associated with the financial contract.

The market-linked activity may further comprise acquiring the designated contract-defined quantity.

The market-linked activity may further comprise producing the designated contract-defined quantity.

The contract-defined quantity may be acquired and stored no later than when the financial contract is established.

The produced-energy product may be stored in a system configured to facilitate providing energy to an economic agent and/or a distribution network of the predetermined market.

Storage of the produced-energy product may comprise converting at least a portion of it to chemical energy.

Storage of the produced-energy product may comprise converting at least a portion of it to mechanical potential energy.

The mechanical potential energy may comprise gravitational energy.

The mechanical potential energy may be stored in a compressed fluid.

Storage of the produced-energy product may comprise converting at least a portion of it to thermal energy.

The produced-energy product may be electricity.

### DETAILED DESCRIPTION OF EMBODIMENTS

According to the presently disclosed subject matter, there is provided a computer system which is configured to facilitate trade of financial contracts related to a produced-energy product. It will be appreciated that herein the present description and appended claims, the term “trade” is used in its broadest sense, including, but not limited to, selling, buying, making an offer to sell, making an offer to buy, etc., any financial contract related to product, including, but not limited to, equity shares, futures contracts, tradeable notes, etc.

It will be further appreciated that the term “produced-energy product” is used to refer to a quantifiable amount of useable energy which has been, or which can be, produced. The produced-energy product may be, but is not limited to, electricity. The produced-energy product is not limited to a directly useable form (e.g., in the case of electricity, it is not limited to an electrical current, for example on an electrical grid and therefore is directly useable without being converted), but may also include a quantifiable amount of useable energy which has been produced and converted to another form of energy which may be stored, for example as is well-known in the art. In the latter case, references to and/or operations to be performed on the produced-energy product may include, implicitly or explicitly, references to and/or operations performed on the stored potential energy resulting from capturing useable energy.

The computer system may comprise one or more modules for its performing operations. According to some examples, it comprises a pricing module configured to determine a unit price for each of the financial contracts, a trading module configured for facilitating different aspects of trading, and a procurement module configured to facilitate performing market-linked activities (i.e., an activity which occurs external to the market, but which is performed in connection with a market activity), to associate financial contracts and/or activities performed therewith with predetermined quantities of the produced-energy product.

The pricing module may be configured to determine a unit price for each of the financial contracts according to any suitable method, many of which are known in the art. In particular, the pricing may be at least partially based at least on a market price for a contract-defined quantity (e.g., expressed in units of energy such as kilowatt-hours, joules, etc.) of the produced-energy product in a predetermined market. The predetermined market may be a geographic area served by a single power utility, one which is served by more than one electric provider all of which are subject to common regulations, a deregulated market in which customers are connected to a common electrical distribution network, etc. According to some examples, the pricing is determined externally of the computer system (e.g., being calculated manually), wherein the pricing module may be constituted by functionality of the system to receive an input of the externally determined unit price for each of the financial contracts.

It will be further appreciated that the pricing module may determine different prices for some of the financial contracts than for others, for example pricing some at a lower price than others. In addition, the unit price may comprise an algorithm by which the unit price may be determined at a given time, for example based on historical data over a predetermined period, available supply of the financial contracts, historical data of trading activity, etc.

The trading module is configured to facilitate different aspects of trading, in particular those which are directly associated with market activity (i.e., to distinguish from trading activities such as pricing, etc., which may be factored into decisions about market activity, are not themselves direct market activities). Accordingly, the trading module may be configured for establishing the financial contracts, for example by populating a database to facilitate overseeing trading of the financial contracts (at least initially), creating entries on an electronic distributed ledger, such as a public blockchain, corresponding to the financial contracts, etc. The trading module may be further configured to directly facilitate trading of financial contracts, for example receiving orders for purchasing of financial contracts, conducting sales and/or purchases of financial contracts, etc.

The procurement module is configured to facilitate one or more market-linked activities which associate one or more actions performed by the trading module with a quantity of the produced-energy product defined by the financial contracts. Accordingly, it may be configured to establish rights related to a quantity of the produced-energy product, designate a quantity of the produced-energy product associated with a financial contract, etc., for example in accordance with terms dictated by the financial contracts.

According to some examples, the market-linked activity is the establishment of a right for the holder of one of the financial contracts to purchase a quantity, defined in the contract, of the produced-energy product at or by a predefined future date at a defined price (e.g., similar to a futures contract). The financial contract may be secured, i.e., the financial contract may stipulate that the owner, until the predetermined date, be in possession of means to deliver the defined quantity of the produced-energy product, e.g., by arrangement with a third-party supplier, storage, availability of an energy-producing arrangement (e.g., a photovoltaic array), etc.

According to some examples, the market-linked activity is the designation of an amount, in a quantity defined by the financial contract, of the produced-energy product, as being exclusively associated with the holder of the financial contract. It will be appreciated that as it is often impractical to designate a particular tangible element of produced-energy product, even if stored (as discussed below), references herein to a quantity of a produced-energy product being designated, associated with, etc., a financial contract may include arrangements in which, e.g., a supply of produced-energy product equal to the quantities defined by a large plurality of the financial contracts are maintained, and an arrangement is provided to guarantee that the quantity defined by each of the financial contracts can be provided. For example, 1,000,000 financial contracts, each defining a quantity of 1 joule of a produced-energy product, may be designated within an arrangement which can provide (e.g., which stores) 1 megajoule; each of the financial contracts would entitle the holder to be provided with 1 joule of the produced-energy product from such an arrangement.

According to some examples, the procurement module is configured to facilitate acquiring the designated contract-defined quantity, for example when a corresponding financial contract is established or initially sold or by a predetermined date.

According to other examples, the procurement module is configured to facilitate production of the designated contract-defined quantity, for example when a corresponding financial contract is established or initially sold or by a predetermined date.

According to some examples, the procurement module is configured to facilitate designating a contract-defined quantity of the produced-energy product which had been acquired and/or produced and subsequently stored prior to establishment or initial sale of a corresponding financial contract.

Storage of the produced-energy product may be in any suitable facility. According to some examples, the facility may be configured to selectively provide the energy to an economic agent (i.e., a seller or a customer) participating in the predetermined market, i.e., to sell it directly to one or more of such economic agents. According to some examples, the facility may be configured to selectively provide the energy a distribution network of the predetermined market, e.g., to supply it to an electrical grid.

The storage may be accomplished by any suitable means. According to some examples, the produced-energy product may be converted to and stored as chemical energy, for example for storage in one or more batteries.

According to other examples, the produced-energy product may be converted to and stored as mechanical potential energy. This may be accomplished, for example, by gravitational energy, such as using a pumped hydroelectric energy storage facility. According to other examples, this may be accomplished using a compressed fluid.

According to other examples, the produced-energy product may be converted to and stored as thermal energy, e.g., using molten salt, one or more phase-change materials, etc.

According to other examples, the produced-energy product may be converted to and stored electromagnetically, e.g., using a capacitor, a superconducting magnetic energy storage system, etc.

The procurement module may be further configured, inter alia, to at least partially direct operations of an energy storage facility, either directly or indirectly. It may be configured to facilitate storage and/or release of the produced-energy product to/from the facility. Moreover, it may be configured to facilitate execution of one or more trade-related activity associated with the performance of an energy-linked activity. For example, upon conversion of a contract-defined quantity of stored produced-energy product to useable energy, the procurement module may be configured to facilitate a trade activity (e.g., upon providing a contract-defined quantity from a storage facility to an electrical distribution system, the procurement module may initiate a process resulting in an invoice being submitted to a provider operating on the electrical distribution system).

It will be recognized that examples, embodiments, modifications, options, etc., described herein are to be construed as inclusive and non-limiting, i.e., two or more examples, etc., described separately herein are not to be construed as being mutually exclusive of one another or in any other way limiting, unless such is explicitly stated and/or is otherwise clear. Those skilled in the art to which this invention pertains will readily appreciate that numerous changes, variations, and modifications can be made without departing from the scope of the presently disclosed subject matter, mutatis mutandis.

1. A computer-implemented method for trading financial contracts related to a produced-energy product, the method comprising:
determining a unit price for each of said financial contracts, the unit price being based at least on a market price for a contract-defined quantity of the produced-energy product in a predetermined market;
establishing, on a computer system, a plurality of said financial contracts;
receiving, on the computer system, an order to purchase one or more of said financial contracts; and
performing, by the computer system, one or more market-linked activities associated with the contract-defined quantity of the produced-energy product when one of said financial contracts is purchased.

2. The computer-implemented method according to claim 1, wherein the market-linked activity comprises establishing a right for the holder of one of the financial contracts to purchase the contract-defined quantity of the produced-energy product at a predefined future date at a defined price.

3. The computer-implemented method according to claim 1, wherein the market-linked activity comprises designating a stored contract-defined quantity of the produced-energy product as being exclusively associated with the financial contract.

4. The computer-implemented method according to claim 3, wherein the market-linked activity further comprises acquiring the designated contract-defined quantity.

5. The computer-implemented method according to claim 3, wherein the market-linked activity further comprises producing the designated contract-defined quantity.

6. The computer-implemented method according to claim 3, wherein the contract-defined quantity is acquired and stored no later than when the financial contract is established.

7. The computer-implemented method according to claim 3, wherein the produced-energy product is stored in a system configured to facilitate providing energy to an economic agent and/or a distribution network of the predetermined market.

8. The computer-implemented method according to claim 3, wherein storage of the produced-energy product comprises converting at least a portion of it to chemical energy.

9. The computer-implemented method according to claim 3, wherein storage of the produced-energy product comprises converting at least a portion of it to mechanical potential energy.

10. The computer-implemented method according to claim 9, wherein the mechanical potential energy comprises gravitational energy.

11. The computer-implemented method according to claim 9, wherein the mechanical potential energy is stored in a compressed fluid.

12. The computer-implemented method according to claim 3, wherein storage of the produced-energy product comprises converting at least a portion of it to thermal energy.

13. The computer-implemented method according to claim 1, wherein the produced-energy product is electricity.

14. A computer system for facilitating trade of financial contracts related to a produced-energy product, the system comprising:
a pricing module configured to determine a unit price for each of said financial contracts, the unit price being based at least on a market price for a contract-defined quantity of the produced-energy product in a predetermined market;
a trading module configured to establish a plurality of said financial contracts and to receive orders to purchase one or more of said financial contracts; and
a procurement module configured to perform one or more market-linked activities associated with the contract-defined quantity of the produced-energy product when one of said financial contracts is purchased.

15. The computer system according to claim 14, wherein the procurement module is configured to establish a right for the holder of one of the financial contracts to purchase the contract-defined quantity of the produced-energy product at a predefined future date at a defined price.

16. The computer system according to claim 14, wherein the procurement module is configured to designate a stored contract-defined quantity of the produced-energy product as being exclusively associated with the financial contract.

17. The computer system according to claim 16, wherein the market-linked activity further comprises acquiring the designated contract-defined quantity.

18. The computer system according to claim 16, wherein the market-linked activity further comprises producing the designated contract-defined quantity.

19. The computer system according to claim 16, wherein the contract-defined quantity is acquired and stored no later than when the financial contract is established.

20. The computer system according to claim 16, wherein the produced-energy product is stored in a system configured to facilitate providing energy to an economic agent and/or a distribution network of the predetermined market.

21. The computer system according to claim 16, wherein storage of the produced-energy product comprises converting at least a portion of it to chemical energy.

22. The computer system according to claim 16, wherein storage of the produced-energy product comprises converting at least a portion of it to mechanical potential energy.

23. The computer system according to claim 22, wherein the mechanical potential energy comprises gravitational energy.

24. The computer system according to claim 22, wherein the mechanical potential energy is stored in a compressed fluid.

25. The computer system according to claim 16, wherein storage of the produced-energy product comprises converting at least a portion of it to thermal energy.

26. The computer system according to claim 14, wherein the produced-energy product is electricity.
